(19) United States
(12) Patent Application Publication
(10) Pub. No.: US 2018/0332498 A1
(43) Pub. Date: Nov. 15, 2018

(54) SIGNALING FOR REPORT CONFIGURATIONS

(71) Applicant: QUALCOMM Incorporated, San Diego, CA (US)

(72) Inventors: Yan Zhou, San Diego, CA (US); Alfred Asterjadhi, San Diego, CA (US); George Cherian, San Diego, CA (US)

(21) Appl. No.: 15/591,026

(22) Filed: May 9, 2017

(51) Int. Cl. H04W 28/02; H04W 72/04

(52) U.S. Cl. CPC H04W 28/0278; H04W 72/0446; H04W 72/042

(57) ABSTRACT

Various aspects of the disclosure relate to determining and communicating report configurations. For example, an access point (AP) determines a configuration of a report to be provided by a station (STA). The configuration may include a desired frame type and/or a desired time for obtaining the report. The configuration may further include a desired content to be included in the report. The AP provides the configuration to the STA, and thereafter, obtains the report from the STA according to the configuration.

Various aspects described herein relate to electronic communication and, more particularly but not exclusively, to determining and communicating report configurations.

In a wireless communication system, a station (STA) may send a report such as a buffer status report (BSR) to an access point (AP) for the purpose of scheduling an uplink (UL) transmission. The BSR may include various types of information, for example, an amount of buffered data per transmission identifier (TID), an amount of buffered data per access category (AC), or an overall amount of buffered data. However, the AP may be only interested in certain types of information. The desired types of information may be dependent on an implementation of the AP's scheduler and/or information already available at the AP.

Current trigger frames for soliciting a BSR are not capable of dynamically configuring a type of information to be included in the BSR. Accordingly, what is needed is a system that facilitates the AP to configure the STA for desired BSR information instead of the STA deciding what types of BSR information to send to the AP, or blindly sending all types of BSR information to the AP, in order to reduce overhead and allow the AP's scheduler to more efficiently schedule uplink transmissions.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one aspect, the disclosure provides an apparatus configured for communication that includes a processing system and an interface coupled to the processing system. The processing system is configured to determine a configuration, wherein the configuration includes a desired frame type for obtaining a report. The interface is configured to output the configuration for transmission and obtain the report according to the configuration after the configuration is output for transmission.

Another aspect of the disclosure provides a method for communication including determining a configuration, wherein the configuration includes a desired frame type for obtaining a report, outputting the configuration for transmission, and obtaining the report according to the configuration after the outputting of the configuration for transmission.

Another aspect of the disclosure provides an apparatus configured for communication. The apparatus includes means for determining a configuration, wherein the configuration includes a desired frame type for obtaining a report, means for outputting the configuration for transmission, and means for obtaining the report according to the configuration after the outputting of the configuration for transmission.

Another aspect of the disclosure provides a computer-readable medium (e.g., a non-transitory computer-readable medium) storing computer-executable code, including code to determine a configuration, wherein the configuration includes a desired frame type for obtaining a report, output the configuration for transmission, and obtain the report according to the configuration after the configuration is output for transmission.

Another aspect of the disclosure provides a wireless node that includes a processing system and a transceiver coupled to the processing system. The processing system is configured to determine a configuration, wherein the configuration includes at least one of a desired frame type or a desired time for obtaining a report. The transceiver is configured to transmit the configuration and to receive the report according to the configuration after the transmission of the configuration.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

The accompanying drawings are presented to aid in the description of aspects of the disclosure and are provided solely for illustration of the aspects and not limitations thereof.

FIG. 1 illustrates an example communication system that determines and communicates buffer status report configurations in accordance with some aspects of the disclosure.

FIG. 2 illustrates another example communication system for communicating a buffer status report configuration in accordance with some aspects of the disclosure.

FIG. 3 illustrates a process for sending a buffer status report configuration and receiving a buffer status report based on the configuration in accordance with some aspects of the disclosure.

FIG. 4 illustrates an example of a wireless communication system in which aspects of the present disclosure may be employed.

FIG. 5 is a functional block diagram of an example apparatus that may be employed within a wireless communication system in accordance with some aspects of the disclosure.

FIG. 6 is a functional block diagram of example components that may be utilized in the apparatus of FIG. 5 to transmit wireless communication.

FIG. 7 is a functional block diagram of example components that may be utilized in the apparatus of FIG. 5 to receive wireless communication.

FIG. 8 is a functional block diagram of an example apparatus in accordance with some aspects of the disclosure.

FIG. 9 is a flow diagram of an example process in accordance with some aspects of the disclosure.

FIG. 10 is a flow diagram of example process operations in accordance with some aspects of the disclosure.

FIG. 11 is a simplified block diagram of several sample aspects of an apparatus configured with functionality in accordance with some aspects of the disclosure.

FIG. 12 is a simplified block diagram of several sample aspects of a memory configured with code in accordance with some aspects of the disclosure.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim. As an example of the above, in some aspects, a method of communication includes determining a configuration, wherein the configuration includes a desired frame type for obtaining a report, providing the configuration for transmission, and obtaining the report according to the configuration.

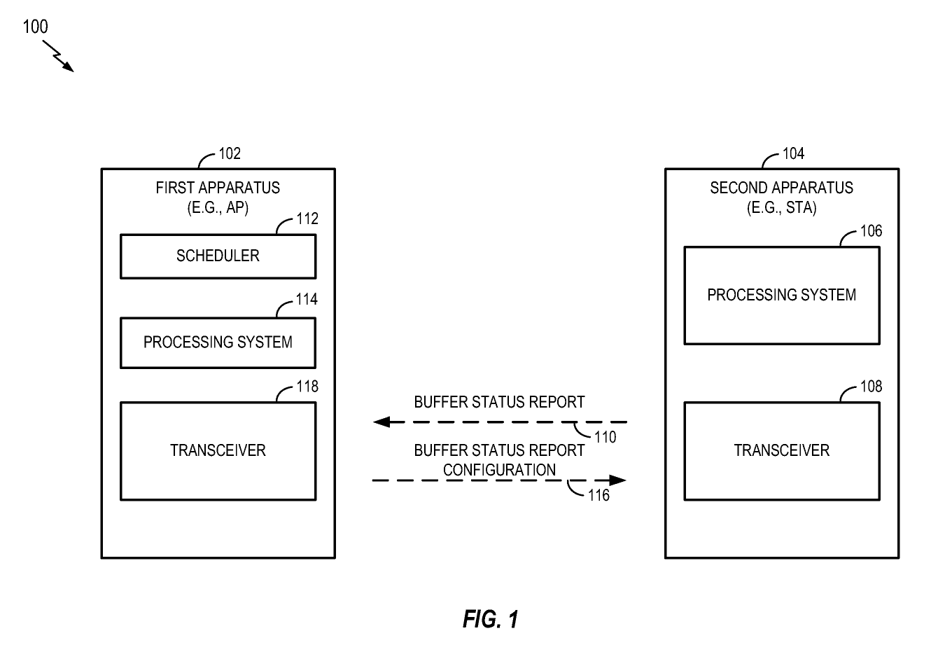

The disclosure relates in some aspects to determining and communicating buffer status report configurations. FIG. 1 illustrates a communication system 100 that includes a first apparatus (e.g., an access point (AP) 102) and a second apparatus (e.g., a station (STA) 102). The AP 102 may include a scheduler 112 for scheduling communications between the AP 102 and the STA 104, a processing system 114 for determining a buffer status report (BSR) configuration, and a transceiver for sending the BSR configuration 116 to the STA 104 and receiving a BSR 110 from the STA 104. The STA 104 may include a processing system 106 for generating the BSR 110 according to the received BSR configuration 116 and a transceiver 108 for receiving the BSR configuration 116 from the AP 102 and sending the BSR 110 to the AP 102. For example, the STA 104 may collect information to be reported, determine based on the BSR configuration which of the collected information is to be included in a BSR, format the BSR according to the BSR as applicable, and send the resulting BSR to the AP 102.

In an aspect, the scheduler 112 may more efficiently schedule communications between the AP 102 and the STA 104 by having the AP 102 send the BSR configuration 116 to the STA 104 to indicate the types of information desired by the AP 102 for inclusion in the BSR 110 and/or how the AP 102 desires the BSR 110 to be sent. This prevents the STA 104 from deciding on its own what types of BSR information to send to the AP 102 (or blindly sending all types of BSR information to the AP 102) and/or what time, or format to use, to send the BSR 110. Accordingly, overhead is reduced since the AP 102 may receive only the BSR information that is desired from the STA 104 at a time, or in a format, desired by the AP 102.

In an aspect, the BSR configuration 116 may indicate to the STA 104 that the BSR configuration applies to a particular type of BSR. For example, it may be indicated that the BSR configuration applies to an autonomous BSR where the STA 104 is to send the BSR 110 without being polled by the AP 102. In another example, it may be indicated that the BSR configuration applies to a polled BSR where the STA 104 is to send the BSR 110 in response to a BSR poll sent from the AP 102.

### BSR Contents Configuration

In an aspect of the disclosure, signaling from the AP to configure the contents of a STA's BSR will be described. Referring to FIG. 1, the AP 102 may send the BSR configuration 116 to the STA 104 to indicate the type(s) of information desired by the AP 102 for inclusion in the BSR 110. The STA 104 may include the desired information in a generated BSR 110 based on the BSR configuration 116. The desired information (i.e., the contents of the BSR 110) may include different levels of details regarding buffered data at the STA 104. For example, the desired information may be an indication of whether buffered data exists at the STA 104. In another example, the desired information may be an amount of buffered data at the STA 104. A scaling factor used to express the amount of the buffered data may also be part of the desired information.

In a further example, the desired information may be detailed information regarding buffered data frames at the STA 104. The detailed information may include a number of buffered data frames and/or statistical information related to a buffered data frame size. The statistical information may include an average buffered data frame size (e.g., an average number of bytes per buffered data frame). Additionally and/or alternatively, the statistical information may include a histogram of buffered data frame sizes (e.g., a distribution of percentages of buffered data frames having a corresponding number of bytes—10% of buffered data frames have 20 bytes, 10% of buffered data frames have between 20 to 100 bytes, etc.)

In an aspect of the disclosure, the AP 102 may indicate via the BSR configuration 116 that the desired information to be included in the BSR 110 applies to buffered data corresponding to a transmission identifier (TID), buffered data corresponding to an access category (AC), or all buffered data. In some aspects, the desired information may apply to buffered data per TID across all TIDs, buffered data per TID for TIDs signaled by the AP 102, buffered data across all TIDs signaled by the AP 102, and/or buffered data of a highest priority TID per AC. In other aspects, the desired information may apply to buffered data per AC across all ACs, buffered data per AC for ACs signaled by the AP 102, buffered data across all ACs, buffered data across all ACs signaled by the AP 102, and/or buffered data of a highest priority AC.

### BSR Frame/Field Type Configuration

In an aspect of the disclosure, signaling from the AP to configure the frame/field type of a STA's BSR will be described. Referring to FIG. 1, the AP 102 may send the BSR configuration 116 to the STA 104 to indicate the type of frame or field desired by the AP 102 for receiving the BSR 110. The STA 104 may send the BSR 110 in the desired frame or field based on the BSR configuration 116.

In an aspect, the BSR configuration 116 may indicate to the STA 104 that the BSR 110 is to be sent via a high efficiency (HE) frame or a non-HE frame. In another aspect, the BSR configuration 116 may indicate to the STA 104 that the BSR 110 is to be sent via a data frame, a Quality of Service (QoS)-null data frame, or a control frame (e.g., an HE control frame or some other type of control frame). In a further aspect, the BSR configuration 116 may indicate to the STA 104 that the BSR 110 is to be sent via a Quality of Service (QoS) field or a high efficiency (HE) control field in a frame.

### BSR Timing Configuration

In an aspect of the disclosure, signaling from the AP to configure the timing of a STA's BSR will be described. Referring to FIG. 1, the AP 102 may send the BSR configuration 116 to the STA 104 to indicate the time desired by the AP 102 for receiving the BSR 110. The STA 104 may send the BSR 110 at the desired time based on the BSR configuration 116.

In an aspect, the BSR configuration 116 may indicate to the STA 104 that the BSR 110 is to be sent immediately after the STA 104 receives a frame soliciting the BSR (BSR soliciting frame). For example, the BSR configuration 116 may indicate that the BSR 110 be sent within a threshold time (e.g., short interframe space (SIFS)) after the STA 104 receives the BSR soliciting frame from the AP 102. In another aspect, the BSR configuration 116 may indicate to the STA 104 that the sending of the BSR 110 is to be delayed after the STA 104 receives the BSR soliciting frame. For example, the BSR configuration 116 may indicate that the BSR 110 be sent in a later transmission opportunity (TxOP) initiated by the STA 104 after the STA 104 receives the BSR soliciting frame.

In a further aspect, the BSR configuration 116 may indicate whether an acknowledgement (ACK) from the STA 104 for the BSR soliciting frame is expected to be received by the AP 102 or not. The BSR configuration 116 may further indicate whether the STA 104 is to wait for an ACK for the BSR 110 from the AP 102 or not.

### Sending the BSR Configuration

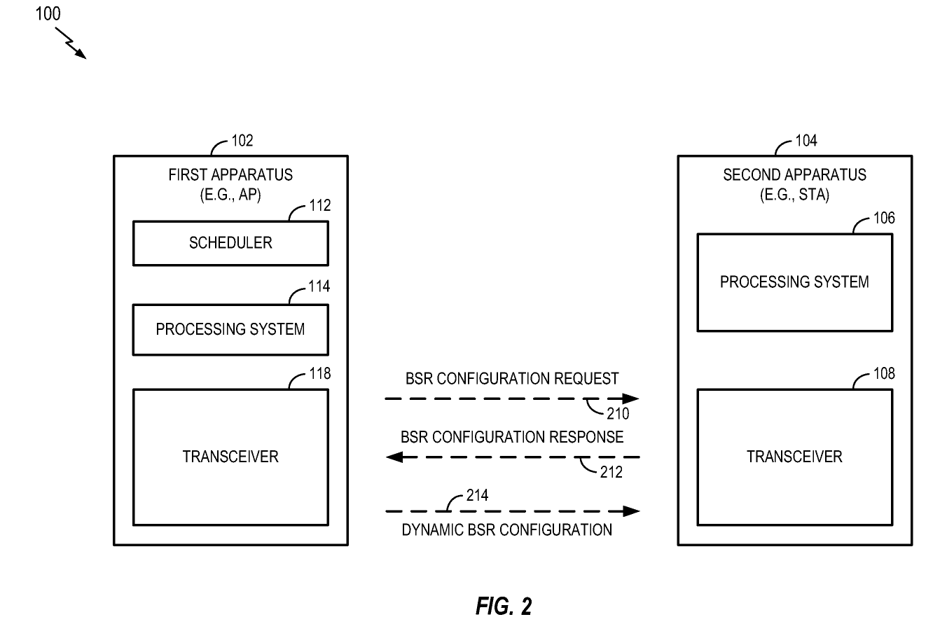

FIG. 2 illustrates the communication system 100 that includes the first apparatus (e.g., an access point (AP) 102) and the second apparatus (e.g., a station (STA) 104) of FIG. 1. Aspects related to sending the BSR configuration from the AP to the STA will be described with reference to FIG. 2.

In an aspect, the AP 102 may send the BSR configuration to the STA 104 via a message exchange. For example, the AP 102 may determine that the BSR configuration is valid for a certain time session. At a beginning of the session, the AP 102 may send a BSR configuration request 210 to the STA 104 to inform the STA 104 of the BSR configuration. Thereafter, the STA 104 may inform the AP 102 of complying with the BSR configuration by sending a BSR configuration response 212.

In another aspect, the AP 102 may dynamically inform the STA 104 of the BSR configuration via a dynamic BSR configuration frame 214 soliciting the BSR from the STA 104. In one example, the BSR configuration frame 214 may be a trigger frame (e.g., BSR-poll variant trigger frame). Accordingly, the BSR configuration may be signaled in a common field or per-user field of the trigger frame. In another example, the BSR configuration frame 214 may be any frame carrying a high efficiency (HE) control field in medium access control (MAC) header, wherein the BSR configuration is signaled in the HE control field.

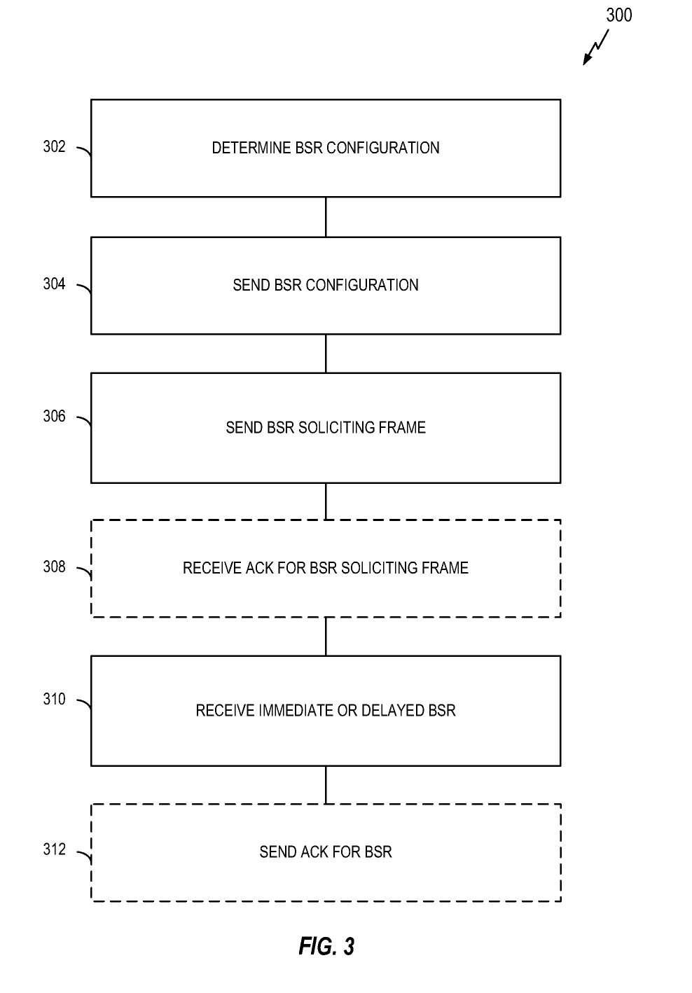

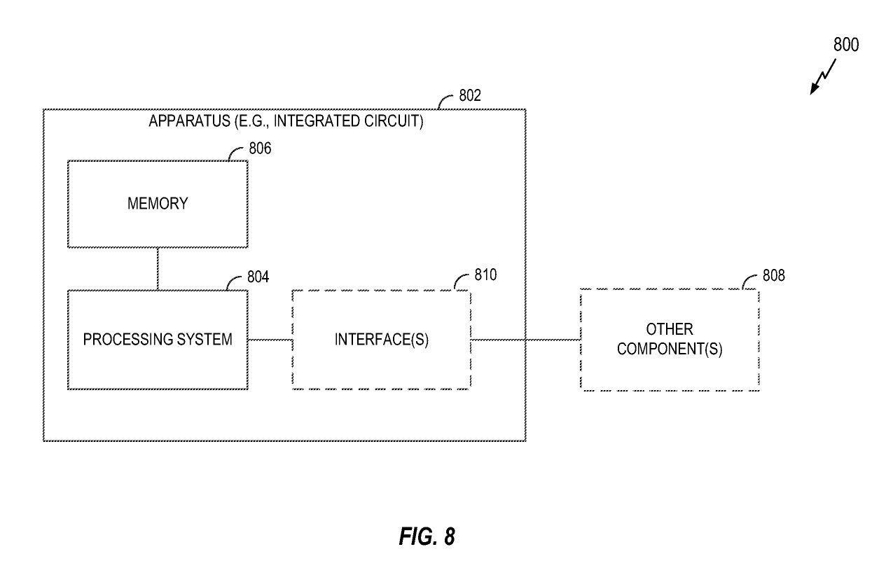

FIG. 3 illustrates a process 300 for sending a BSR configuration and receiving a BSR based on the BSR configuration in accordance with some aspects of the disclosure. The process 300 may take place within a processing system (e.g., the processing system 804 of FIG. 8), which may be located in an access point (AP), an access terminal (AT), or some other suitable apparatus. Of course, in various aspects within the scope of the disclosure, the process 300 may be implemented by any suitable apparatus capable of supporting communication-related operations.

At block 302, an apparatus determines a BSR configuration. For example, the BSR configuration may configure a BSR to be received based on content, a frame/field type, and/or timing, as described above.

At block 304, the apparatus sends the BSR configuration. The BSR configuration may be sent via a message exchange at a beginning of a session or dynamically sent via a frame.

At block 306, the apparatus sends a BSR soliciting frame to provoke the sending of the BSR. The apparatus may receive the BSR immediately (immediate BSR), or after a delay (delayed BSR), subsequent to the BSR soliciting frame being sent, as described above.

At block 308, the apparatus may optionally receive an acknowledgement (ACK) for the BSR soliciting frame. The apparatus may receive the ACK (for the BSR soliciting frame) if the BSR configuration indicates that such ACK is expected to be received from a sender of the BSR.

At block 310, the apparatus receives the BSR according to the BSR configuration. The BSR may be an immediate BSR or a delayed BSR.

At block 312, the apparatus may optionally send an ACK for the BSR. The apparatus may send the ACK (for the BSR) if the BSR configuration indicates that the sender of the BSR is expected to wait for such ACK.

### Example Wireless Communication System

The teachings herein may be implemented using various wireless technologies and/or various spectra. Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communication, a combination of OFDM and DSSS communication, or other schemes.

Certain of the devices described herein may further implement Multiple Input Multiple Output (MIMO) technology and be implemented as part of an 802.11 protocol. A MIMO system employs multiple (Nₜ) transmit antennas and multiple (Nᵣ) receive antennas for data transmission. A MIMO channel formed by the Nₜ transmit and Nᵣ receive antennas may be decomposed into Nₛ independent channels, which are also referred to as spatial channels or streams, where Nₛ≤min{Nₜ, Nᵣ}. Each of the Nₛ independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that access the wireless network. For example, there may be two types of devices: access points (“APs”) and clients (also referred to as stations, or “STAs”). In general, an AP serves as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point (“AP”) may also comprise, be implemented as, or known as a Transmit Receive Point (TRP), a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

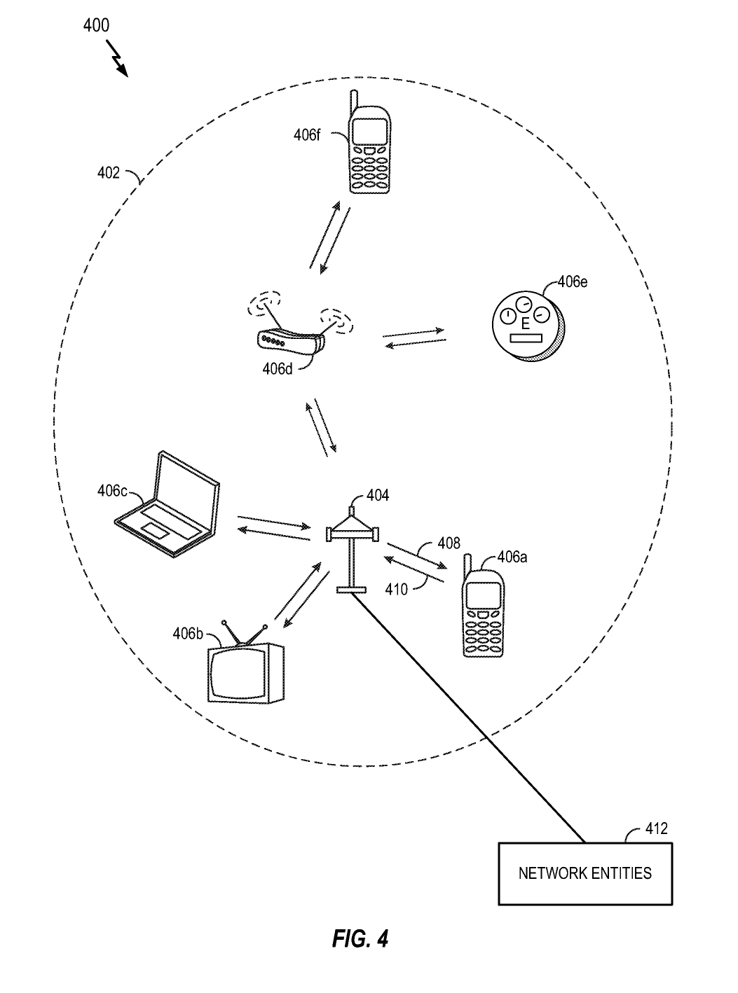

FIG. 4 illustrates an example of a wireless communication system 400 in which aspects of the present disclosure may be employed. The wireless communication system 400 may operate pursuant to a wireless standard, for example the 802.11 standard. The wireless communication system 400 may include an AP 404, which communicates with STAs 406a, 406b, 406c, 406d, 406e, and 406f (collectively STAs 406).

STAs 406e and 406f may have difficulty communicating with the AP 404 or may be out of range and unable to communicate with the AP 404. As such, another STA 406d may be configured as a relay device (e.g., a device comprising STA and AP functionality) that relays communication between the AP 404 and the STAs 406e and 406f.

A variety of processes and methods may be used for transmissions in the wireless communication system 400 between the AP 404 and the STAs 406. For example, signals may be sent and received between the AP 404 and the STAs 406 in accordance with OFDM/OFDMA techniques. If this is the case, the wireless communication system 400 may be referred to as an OFDM/OFDMA system. Alternatively, signals may be sent and received between the AP 404 and the STAs 406 in accordance with CDMA techniques. If this is the case, the wireless communication system 400 may be referred to as a CDMA system.

A communication link that facilitates transmission from the AP 404 to one or more of the STAs 406 may be referred to as a downlink (DL) 408, and a communication link that facilitates transmission from one or more of the STAs 406 to the AP 404 may be referred to as an uplink (UL) 410. Alternatively, a downlink 408 may be referred to as a forward link or a forward channel, and an uplink 410 may be referred to as a reverse link or a reverse channel.

The AP 404 may act as a base station and provide wireless communication coverage in a basic service area (BSA) 402. The AP 404 along with the STAs 406 associated with the AP 404 and that use the AP 404 for communication may be referred to as a basic service set (BSS).

Access points may thus be deployed in a communication network to provide access to one or more services (e.g., network connectivity) for one or more access terminals that may be installed within or that may roam throughout a coverage area of the network. For example, at various points in time an access terminal may connect to the AP 404 or to some other access point in the network (not shown).

Each of the access points may communicate with one or more network entities (represented, for convenience, by network entities 412 in FIG. 4), including each other, to facilitate wide area network connectivity. A network entity may take various forms such as, for example, one or more radio and/or core network entities. Thus, in various implementations the network entities 412 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

It should be noted that in some implementations the wireless communication system 400 might not have a central AP 404, but rather may function as a peer-to-peer network between the STAs 406. Accordingly, the functions of the AP 404 described herein may alternatively be performed by one or more of the STAs 406. Also, as mentioned above, a relay may incorporate at least some of the functionality of an AP and a STA.

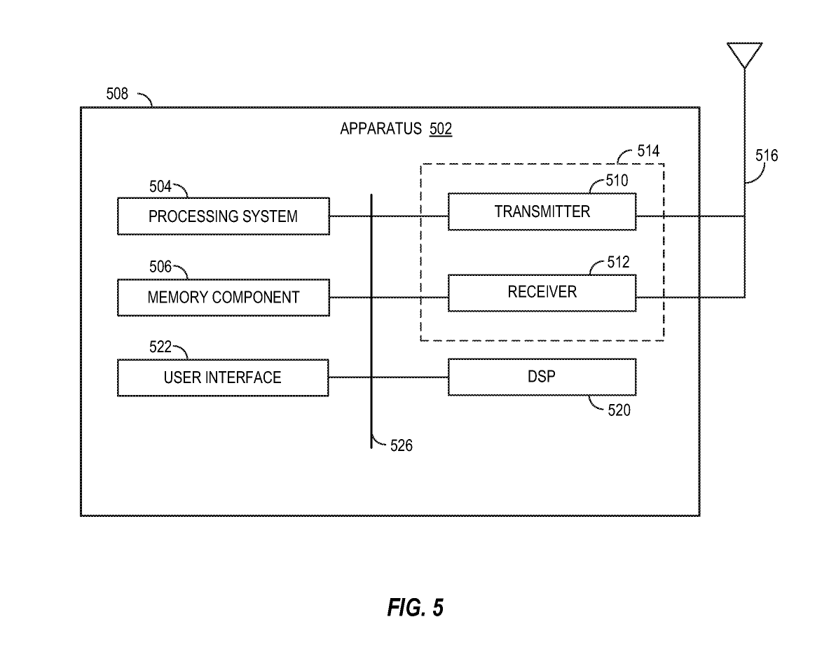

FIG. 5 illustrates various components that may be utilized in an apparatus 502 (e.g., a wireless device) that may be employed within the wireless communication system 400. The apparatus 502 is an example of a device that may be configured to implement the various methods described herein. For example, the apparatus 502 may comprise the AP 404, a relay (e.g., the STA 406d), or one of the STAs 406 of FIG. 4.

The apparatus 502 may include a processing system 504 that controls operation of the apparatus 502. The processing system 504 may also be referred to as a central processing unit (CPU). A memory component 506 (e.g., including a memory device), which may include both read-only memory (ROM) and random access memory (RAM), provides instructions and data to the processing system 504. A portion of the memory component 506 may also include non-volatile random access memory (NVRAM). The processing system 504 typically performs logical and arithmetic operations based on program instructions stored within the memory component 506. The instructions in the memory component 506 may be executable to implement the methods described herein.

When the apparatus 502 is implemented or used as a transmitting node, the processing system 504 may be configured to select one of a plurality of media access control (MAC) header types, and to generate a packet having that MAC header type. For example, the processing system 504 may be configured to generate a packet comprising a MAC header and a payload and to determine what type of MAC header to use.

When the apparatus 502 is implemented or used as a receiving node, the processing system 504 may be configured to process packets of a plurality of different MAC header types. For example, the processing system 504 may be configured to determine the type of MAC header used in a packet and process the packet and/or fields of the MAC header.

The processing system 504 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 502 may also include a housing 508 that may include a transmitter 510 and a receiver 512 to allow transmission and reception of data between the apparatus 502 and a remote location. The transmitter 510 and receiver 512 may be combined into single communication device (e.g., a transceiver 514). An antenna 516 may be attached to the housing 508 and electrically coupled to the transceiver 514. The apparatus 502 may also include (not shown) multiple transmitters, multiple receivers, multiple transceivers, and/or multiple antennas. A transmitter 510 and a receiver 512 may comprise an integrated device (e.g., embodied as a transmitter circuit and a receiver circuit of a single communication device) in some implementations, may comprise a separate transmitter device and a separate receiver device in some implementations, or may be embodied in other ways in other implementations.

The transmitter 510 may be configured to wirelessly transmit packets having different MAC header types. For example, the transmitter 510 may be configured to transmit packets with different types of headers generated by the processing system 504, discussed above.

The receiver 512 may be configured to wirelessly receive packets having different MAC header types. In some aspects, the receiver 512 is configured to detect a type of a MAC header used and process the packet accordingly.

The receiver 512 may be used to detect and quantify the level of signals received by the transceiver 514. The receiver 512 may detect such signals as total energy, energy per subcarrier per symbol, power spectral density and other signals. The apparatus 502 may also include a digital signal processor (DSP) 520 for use in processing signals. The DSP 520 may be configured to generate a data unit for transmission. In some aspects, the data unit may comprise a physical layer data unit (PPDU). In some aspects, the PPDU is referred to as a packet.

The apparatus 502 may further comprise a user interface 522 in some aspects. The user interface 522 may comprise a keypad, a microphone, a speaker, and/or a display. The user interface 522 may include any element or component that conveys information to a user of the apparatus 502 and/or receives input from the user.

The various components of the apparatus 502 may be coupled together by a bus system 526. The bus system 526 may include a data bus, for example, as well as a power bus, a control signal bus, and a status signal bus in addition to the data bus. Those of skill in the art will appreciate the components of the apparatus 502 may be coupled together or accept or provide inputs to each other using some other mechanism.

Although a number of separate components are illustrated in FIG. 5, one or more of the components may be combined or commonly implemented. For example, the processing system 504 may be used to implement not only the functionality described above with respect to the processing system 504, but also to implement the functionality described above with respect to the transceiver 514 and/or the DSP 520. Further, each of the components illustrated in FIG. 5 may be implemented using a plurality of separate elements. Furthermore, the processing system 504 may be used to implement any of the components, modules, circuits, or the like described below, or each may be implemented using a plurality of separate elements.

For ease of reference, when the apparatus 502 is configured as a transmitting node, it is hereinafter referred to as an apparatus 502t. Similarly, when the apparatus 502 is configured as a receiving node, it is hereinafter referred to as an apparatus 502r. A device in the wireless communication system 400 may implement only functionality of a transmitting node, only functionality of a receiving node, or functionality of both a transmitting node and a receive node.

As discussed above, the apparatus 502 may comprise an AP 404 or a STA 406, and may be used to transmit and/or receive communication having a plurality of MAC header types.

The components of FIG. 5 may be implemented in various ways. In some implementations, the components of FIG. 5 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 5 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

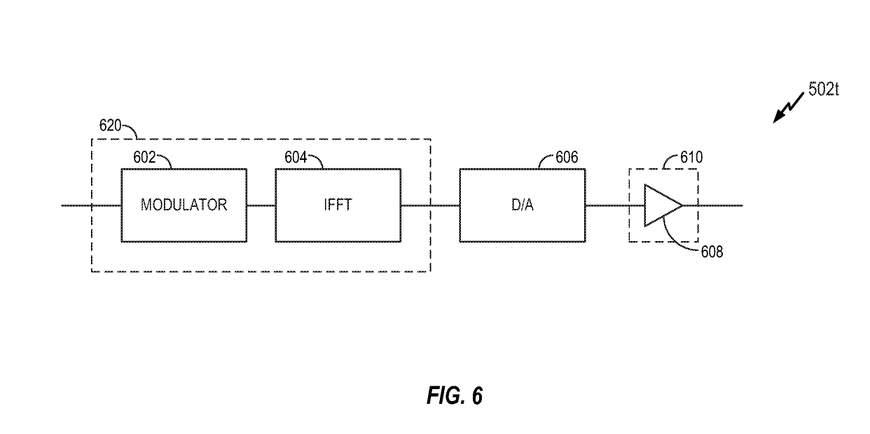

As discussed above, the apparatus 502 may comprise an AP 404 or a STA 406, a relay, or some other type of apparatus, and may be used to transmit and/or receive communication. FIG. 6 illustrates various components that may be utilized in the apparatus 502t to transmit wireless communication. The components illustrated in FIG. 6 may be used, for example, to transmit OFDM communication. In some aspects, the components illustrated in FIG. 6 are used to generate and transmit packets to be sent over a bandwidth of less than or equal to 1 MHz.

The apparatus 502t of FIG. 6 may comprise a modulator 602 configured to modulate bits for transmission. For example, the modulator 602 may determine a plurality of symbols from bits received from the processing system 504 (FIG. 5) or the user interface 522 (FIG. 5), for example by mapping bits to a plurality of symbols according to a constellation. The bits may correspond to user data or to control information. In some aspects, the bits are received in codewords. In one aspect, the modulator 602 may comprise a QAM (quadrature amplitude modulation) modulator, for example, a 16-QAM modulator or a 64-QAM modulator. In other aspects, the modulator 602 may comprise a binary phase-shift keying (BPSK) modulator, a quadrature phase-shift keying (QPSK) modulator, or an 8-PSK modulator.

The apparatus 502t may further comprise a transform module 604 configured to convert symbols or otherwise modulated bits from the modulator 602 into a time domain. In FIG. 6, the transform module 604 is illustrated as being implemented by an inverse fast Fourier transform (IFFT) module. In some implementations, there may be multiple transform modules (not shown) that transform units of data of different sizes. In some implementations, the transform module 604 may be itself configured to transform units of data of different sizes. For example, the transform module 604 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 604 may be referred to as the size of the transform module 604.

In FIG. 6, the modulator 602 and the transform module 604 are illustrated as being implemented in the DSP 620. In some aspects, however, one or both of the modulator 602 and the transform module 604 are implemented in the processing system 504 or in another element of the apparatus 502t (e.g., see description above with reference to FIG. 5).

As discussed above, the DSP 620 may be configured to generate a data unit for transmission. In some aspects, the modulator 602 and the transform module 604 may be configured to generate a data unit comprising a plurality of fields including control information and a plurality of data symbols.

Returning to the description of FIG. 6, the apparatus 502t may further comprise a digital to analog converter 606 configured to convert the output of the transform module into an analog signal. For example, the time-domain output of the transform module 604 may be converted to a baseband OFDM signal by the digital to analog converter 606. The digital to analog converter 606 may be implemented in the processing system 504 or in another element of the apparatus 502 of FIG. 5. In some aspects, the digital to analog converter 606 is implemented in the transceiver 514 (FIG. 5) or in a data transmit processor.

The analog signal may be wirelessly transmitted by the transmitter 610. The analog signal may be further processed before being transmitted by the transmitter 610, for example by being filtered or by being upconverted to an intermediate or carrier frequency. In the aspect illustrated in FIG. 6, the transmitter 610 includes a transmit amplifier 608. Prior to being transmitted, the analog signal may be amplified by the transmit amplifier 608. In some aspects, the amplifier 608 comprises a low noise amplifier (LNA).

The transmitter 610 is configured to transmit one or more packets or data units in a wireless signal based on the analog signal. The data units may be generated using the processing system 504 (FIG. 5) and/or the DSP 620, for example using the modulator 602 and the transform module 604 as discussed above. Data units that may be generated and transmitted as discussed above are described in additional detail below.

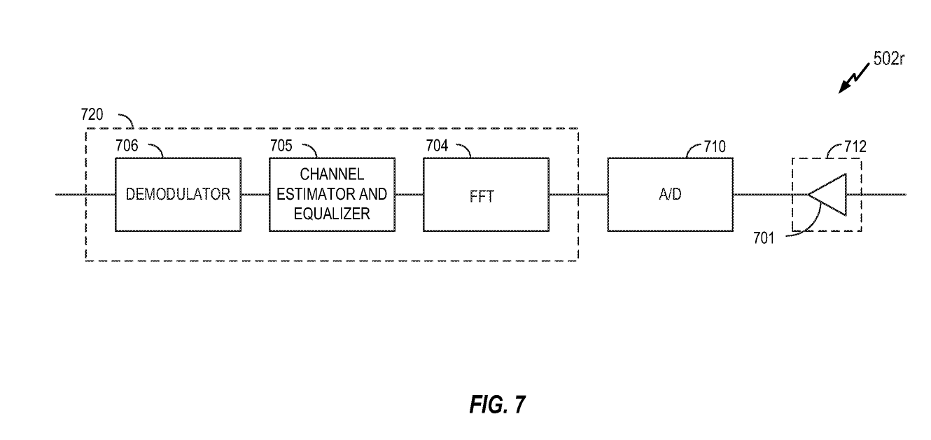

FIG. 7 illustrates various components that may be utilized in the apparatus 502 of FIG. 5 to receive wireless communication. The components illustrated in FIG. 7 may be used, for example, to receive 01-DM communication. For example, the components illustrated in FIG. 7 may be used to receive data units transmitted by the components discussed above with respect to FIG. 6.

The receiver 712 of apparatus 502r is configured to receive one or more packets or data units in a wireless signal. Data units that may be received and decoded or otherwise processed as discussed below.

In the aspect illustrated in FIG. 7, the receiver 712 includes a receive amplifier 701. The receive amplifier 701 may be configured to amplify the wireless signal received by the receiver 712. In some aspects, the receiver 712 is configured to adjust the gain of the receive amplifier 701 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 701 comprises an LNA.

The apparatus 502r may comprise an analog to digital converter 710 configured to convert the amplified wireless signal from the receiver 712 into a digital representation thereof. Further to being amplified, the wireless signal may be processed before being converted by the analog to digital converter 710, for example by being filtered or by being downconverted to an intermediate or baseband frequency. The analog to digital converter 710 may be implemented in the processing system 504 (FIG. 5) or in another element of the apparatus 502r. In some aspects, the analog to digital converter 710 is implemented in the transceiver 514 (FIG. 5) or in a data receive processor.

The apparatus 502r may further comprise a transform module 704 configured to convert the representation of the wireless signal into a frequency spectrum. In FIG. 7, the transform module 704 is illustrated as being implemented by a fast Fourier transform (FFT) module. In some aspects, the transform module may identify a symbol for each point that it uses. As described above with reference to FIG. 6, the transform module 704 may be configured with a plurality of modes, and may use a different number of points to convert the signal in each mode. The number of points used by the transform module 704 may be referred to as the size of the transform module 704. In some aspects, the transform module 704 may identify a symbol for each point that it uses.

The apparatus 502r may further comprise a channel estimator and equalizer 705 configured to form an estimate of the channel over which the data unit is received, and to remove certain effects of the channel based on the channel estimate. For example, the channel estimator and equalizer 705 may be configured to approximate a function of the channel, and the channel equalizer may be configured to apply an inverse of that function to the data in the frequency spectrum.

The apparatus 502r may further comprise a demodulator 706 configured to demodulate the equalized data. For example, the demodulator 706 may determine a plurality of bits from symbols output by the transform module 704 and the channel estimator and equalizer 705, for example by reversing a mapping of bits to a symbol in a constellation. The bits may be processed or evaluated by the processing system 504 (FIG. 5), or used to display or otherwise output information to the user interface 522 (FIG. 5). In this way, data and/or information may be decoded. In some aspects, the bits correspond to codewords. In one aspect, the demodulator 706 comprises a QAM (quadrature amplitude modulation) demodulator, for example an 8-QAM demodulator or a 64-QAM demodulator. In other aspects, the demodulator 706 comprises a binary phase-shift keying (BPSK) demodulator or a quadrature phase-shift keying (QPSK) demodulator.

In FIG. 7, the transform module 704, the channel estimator and equalizer 705, and the demodulator 706 are illustrated as being implemented in the DSP 720. In some aspects, however, one or more of the transform module 704, the channel estimator and equalizer 705, and the demodulator 706 are implemented in the processing system 504 (FIG. 5) or in another element of the apparatus 502 (FIG. 5).

As discussed above, the wireless signal received at the receiver 512 comprises one or more data units. Using the functions or components described above, the data units or data symbols therein may be decoded evaluated or otherwise evaluated or processed. For example, the processing system 504 (FIG. 5) and/or the DSP 720 may be used to decode data symbols in the data units using the transform module 704, the channel estimator and equalizer 705, and the demodulator 706.

Data units exchanged by the AP 404 and the STA 406 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized

The apparatus 502t shown in FIG. 6 is an example of a single transmit chain used for transmitting via an antenna. The apparatus 502r shown in FIG. 7 is an example of a single receive chain used for receiving via an antenna. In some implementations, the apparatus 502t or 502r may implement a portion of a MIMO system using multiple antennas to simultaneously transmit data.

The wireless communication system 400 may employ methods to allow efficient access of the wireless medium based on unpredictable data transmissions while avoiding collisions. As such, in accordance with various aspects, the wireless communication system 400 performs carrier sense multiple access/collision avoidance (CSMA/CA) that may be referred to as the Distributed Coordination Function (DCF). More generally, an apparatus 502 having data for transmission senses the wireless medium to determine if the channel is already occupied. If the apparatus 502 senses the channel is idle, then the apparatus 502 transmits prepared data. Otherwise, the apparatus 502 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one that must wait longer before attempting to access the channel

A wireless apparatus may include various components that perform functions based on signals that are transmitted by or received at the wireless apparatus. For example, in some implementations a wireless apparatus comprises a user interface configured to output an indication based on a received signal as taught herein.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, an apparatus (e.g., a wireless apparatus) implemented in accordance with the teachings herein may comprise an access point, a relay, or an access terminal.

An access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

A relay may comprise, be implemented as, or known as a relay node, a relay device, a relay station, a relay apparatus, or some other similar terminology. As discussed above, in some aspects, a relay may comprise some access terminal functionality and some access point functionality.

In some aspects, a wireless apparatus comprises an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3^{rd} Generation Partnership Project” (3GPP), while cdma2000 is described in documents from an organization named “3^{rd} Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

### Example Communication Device

FIG. 8 illustrates an example apparatus 800 (e.g., an AP, an AT (a STA), or some other type of wireless communication node) according to certain aspects of the disclosure. The apparatus 800 includes an apparatus 802 (e.g., an integrated circuit). In some aspects, the apparatus 802 may be configured to operate in a wireless communication node (e.g., the AP 102 or the STA 104 of FIG. 1) and to perform one or more of the operations described herein. For convenience, a wireless communication node may be referred to as a wireless node herein. The apparatus 802 includes a processing system 804, and a memory 806 coupled to the processing system 804. Example implementations of the processing system 804 are provided herein. In some aspects, the processing system 804 and the memory 806 of FIG. 8 may correspond to the processing system 504 and the memory component 506 of FIG. 5.

The processing system 804 is generally adapted for processing, including the execution of such programming stored on the memory 806. For example, the memory 806 may store instructions that, when executed by the processing system 804, cause the processing system 804 to perform one or more of the operations described herein. As used herein, the terms “programming” or “instructions” or “code” shall be construed broadly to include without limitation instruction sets, instructions, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some implementations, the apparatus 802 communicates with at least one other component 808 (e.g., a component external to the apparatus 802) of the apparatus 800. To this end, in some implementations, the apparatus 802 may include at least one interface 810 (e.g., an interface bus, bus drivers, bus receivers, a send/receive interface, or other suitable circuitry) coupled to the processing system 804 for communicating information (e.g., received information, decoded information, messages, etc.) between the processing system 804 and the other component 808. In some implementations, the interface 810 may be configured to interface the processing system 804 to one or more other components (e.g., a radio frequency (RF) front end (e.g., a transmitter and/or a receiver)) of the apparatus 800 (other components not shown in FIG. 8). In some implementations, the interface 810 may include RF circuitry.

The apparatus 802 may communicate with other apparatuses in various ways. In cases where the apparatus 802 include an RF transceiver (not shown in FIG. 8), the apparatus may transmit and receive information (e.g. a frame, a message, bits, etc.) via RF signaling. In some cases, rather than transmitting information via RF signaling, the apparatus 802 may have an interface to provide (e.g., output, send, transmit, etc.) information for RF transmission. For example, the processing system may output information, via a bus interface, to an RF front end for RF transmission. Similarly, rather than receiving information via RF signaling, the apparatus 802 may have an interface to obtain information that is received by another apparatus. For example, the processing system may obtain (e.g., receive) information, via a bus interface, from an RF receiver that received the information via RF signaling.

### Example Processes

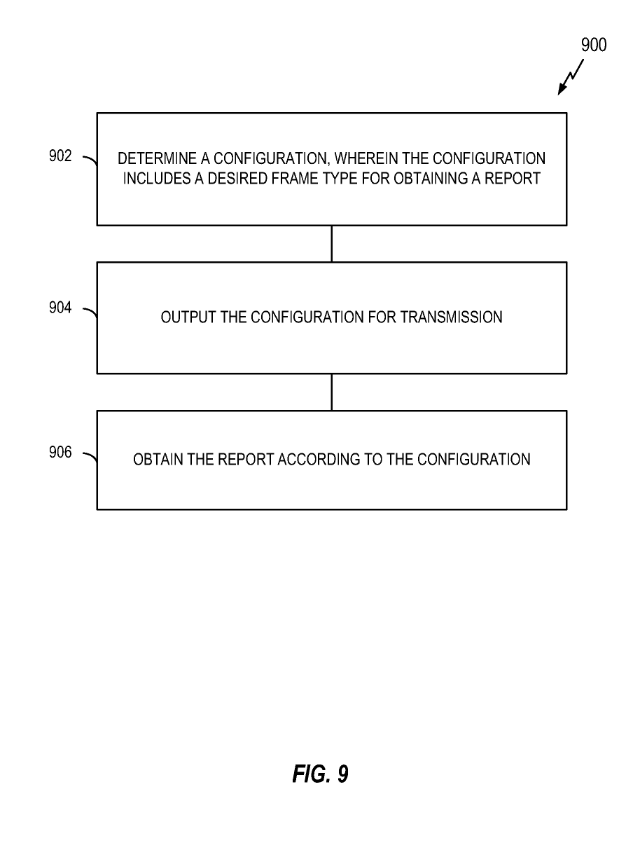

FIG. 9 illustrates a process 900 for communication in accordance with some aspects of the disclosure. The process 900 may take place within a processing system (e.g., the processing system 804 of FIG. 8), which may be located in an AP, an AT, or some other suitable apparatus. Of course, in various aspects within the scope of the disclosure, the process 900 may be implemented by any suitable apparatus capable of supporting communication-related operations.

At block 902, an apparatus (e.g., an AP) determines a configuration. The configuration may include a desired frame type and/or a desired time for obtaining a report. For example, an AP may determine a configuration for a buffer status report (BSR). In some aspects, the determination of the report may include selecting the desired frame type based on a type of the report. For example, one type of report may be carried in a different field and/or frame than another type of report.

In an aspect, the desired frame type may indicate whether the report is to be obtained via a high efficiency (HE) frame or a non-HE frame. In another aspect, the desired frame type may indicate whether the report is to be obtained via a data frame, a Quality of Service (QoS)-null data frame, or a control frame (e.g., an HE control frame). In a further aspect, the desired frame type may indicate whether the report is to be obtained via a Quality of Service (QoS) field or a high efficiency (HE) control field in a frame.

In an aspect, the configuration may further include a desired time for obtaining the report. In another aspect, the desired time includes a time within a threshold after the configuration is output for transmission. In another aspect, the desired time includes a time during a transmission opportunity (TXOP) initiated by a sender of the report after the configuration is output for transmission. In another aspect, the desired time is a time within a threshold (e.g., SIFS) after a frame for soliciting the report (e.g., a BSR soliciting frame or trigger frame) is output to a sender of the report. In another aspect, the desired time is a time during a transmission opportunity (TXOP) initiated by the sender of the report after the frame for soliciting the report is output to the sender of the report.

In an aspect, the configuration may further include an indication of whether acknowledgement of the configuration is expected. Accordingly, the configuration may include an indication of whether an acknowledgement for a frame soliciting the report is expected to be obtained from the sender of the report. Additionally or alternatively, the configuration may include an indication of whether a sender of the report is to wait for an acknowledgement of the report.

In an aspect, the configuration may further include an indication of a desired content to be included in the report. The desired content may include an indication of whether buffered data exists, an amount of the buffered data, information related to at least one buffered data frame, or any combination thereof. The desired content may further include a scaling factor used to express the amount of the buffered data. The information related to the at least one buffered data frame may include a number of buffered data frames, an average number of bytes per buffered data frame, a percentage of buffered data frames having a corresponding number of bytes, or any combination thereof. In an aspect, the configuration may further include an indication that the desired content applies to buffered data corresponding to a transmission identifier (TID), buffered data corresponding to an access category (AC), all buffered data, or any combination thereof. In another aspect, the configuration may further include an indication that the configuration applies to an autonomous report and/or a polled report.

At block 904, the apparatus outputs the configuration for transmission. For example, a processing system of the apparatus may output a digital signal including the configuration from an interface, a transceiver, or some other component. As another example, an interface or a transceiver may transmit a signal including the configuration.

In an aspect, the apparatus may output the configuration for transmission by determining a session for when the configuration is valid and providing the configuration at a beginning of the session. In another aspect, the apparatus output the configuration for transmission by providing the configuration via a common field or per-user field of a trigger frame soliciting the report and/or providing the configuration via a high efficiency (HE) control field in a medium access control (MAC) header of a frame soliciting the report.

At block 906, the apparatus obtains the report according to the configuration. In some aspects, the report may be obtained after outputting the configuration for transmission at block 904. For example, a processing system of the apparatus may receive a digital signal including the report from a receive interface, a transceiver, or some other component. As another example, an interface or a transceiver may receive a signal including the report.

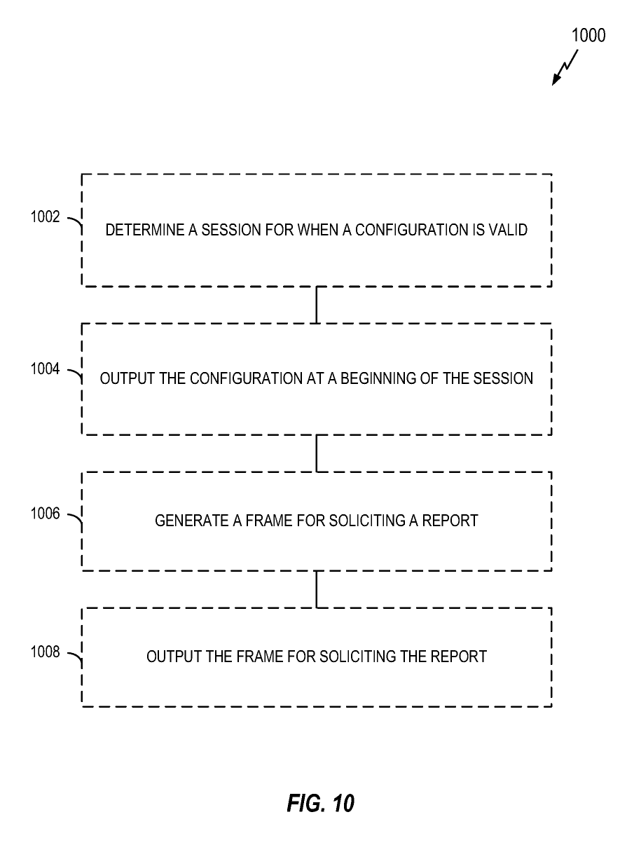

FIG. 10 illustrates a process 1000 for communication in accordance with some aspects of the disclosure. The process 1000 may take place within a processing system (e.g., the processing system 804 of FIG. 8), which may be located in an AP, an AT, or some other suitable apparatus. Of course, in various aspects within the scope of the disclosure, the process 1000 may be implemented by any suitable apparatus capable of supporting communication-related operations.

At optional block 1002, an apparatus (e.g., an AP) may determine a session for when a configuration (e.g., the configuration of block 902 of FIG. 9) is valid.

At optional block 1004, the apparatus may output the configuration at a beginning of the session of block 1002.

At optional block 1006, the apparatus may generate a frame (e.g., a soliciting frame or a trigger frame) for soliciting a report (e.g., a BSR).

At optional block 1008, the apparatus may output the frame generated at block 1006 (e.g., for transmission).

### Example Apparatus

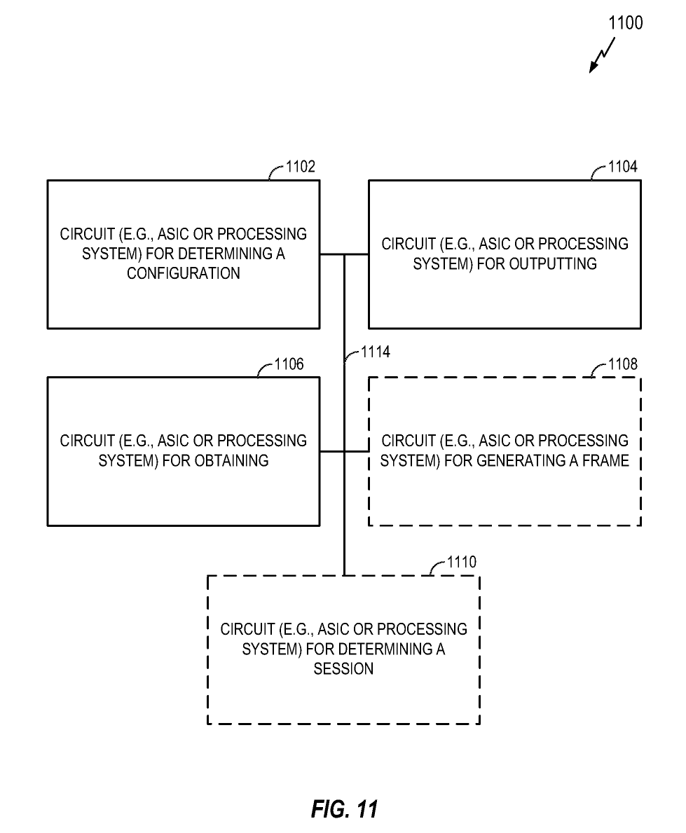

The components described herein may be implemented in a variety of ways. Referring to FIG. 11, an apparatus 1100 is represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 1100 includes one or more components (modules) that may perform one or more of the functions described herein with regard to various figures. For example, a circuit (e.g., an ASIC) for determining a configuration 1102, e.g., a means for determining a configuration, may correspond to, for example, a processing system as discussed herein. In some aspects, the circuit for determining a configuration 1102 may perform the corresponding operations described above in conjunction with FIGS. 1, 2, 3, 9, and 10. For example, an AP may generate a configuration to configure a BSR based on content, a frame/field type, and/or timing, as described above. As another example, a STA may determine the configuration to be used for a BSR based on configuration information received from an AP. A circuit (e.g., an ASIC or a processing system) for outputting 1104, e.g., a means for outputting, may correspond to, for example, an interface (e.g., a bus interface, a send/receive interface), a communication device, a transceiver, a transmitter, or some other similar component as discussed herein. In some aspects, the circuit for outputting 1104 may perform the corresponding operations described above in conjunction with FIGS. 1, 2, 3, 9, and 10. For example, a configuration may be output for transmission. As another example, a BSR soliciting frame may be output to provoke the sending of the BSR. As yet another example, a BSR may be output for transmission. A circuit (e.g., an ASIC or a processing system) for obtaining 1106, e.g., a means for obtaining, may correspond to, for example, an interface (e.g., a bus interface, a send/receive interface), a communication device, a transceiver, a receiver, or some other similar component as discussed herein. In some aspects, the circuit for obtaining 1106 may perform the corresponding operations described above in conjunction with FIGS. 1, 2, 3, 9, and 10. For example, a BSR may be obtained. As another example, an ACK may be obtained with regard to a provided BSR soliciting frame. As yet another example, BSR configuration information may be obtained. A circuit (e.g., an ASIC or a processing system) for generating a frame 1108, e.g., a means for generating a frame, may correspond to, for example, a processing system as discussed herein. In some aspects, the circuit for generating a frame 1108 may perform the corresponding operations described above in conjunction with FIGS. 1, 2, 3, 9, and 10. A circuit (e.g., an ASIC or a processing system) for determining a session 1110, e.g., a means for determining a session, may correspond to, for example, a processing system as discussed herein. In some aspects, the circuit for determining a session 1110 may perform the corresponding operations described above in conjunction with FIGS. 1, 2, 3, 9, and 10.

Two or more of the modules of FIG. 11 may communicate with each other or some other component via a signaling bus 1114. In various implementations, the processing system 504 of FIG. 5 and/or the processing system 804 of FIG. 8 may include one or more of the circuits of FIG. 11.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes are optional.

As noted above, the apparatus 1100 may include one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 1100 may be a single device (e.g., with circuits 1102 - 1110 implemented as different sections of an ASIC). As another specific example, the apparatus 1100 may be several devices (e.g., with the circuits 1102, 1108, and 1110 implemented as one ASIC, and the circuits 1104 and 1106 implemented as another ASIC).

In addition, the components and functions represented by FIG. 11 as well as other components and functions described herein, may be implemented using any suitable means. Such means are implemented, at least in part, using corresponding structure as taught herein. For example, the components described above in conjunction with the “ASIC for” components of FIG. 11 correspond to similarly designated “means for” functionality. Thus, one or more of such means is implemented using one or more of processor components, integrated circuits, or other suitable structure as taught herein in some implementations.

The various operations of methods described herein may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar functionality and/or numbering. For example, the blocks of the process 300 illustrated in FIG. 3 or the process 900 illustrated in FIG. 9 may correspond at least in some aspects, to corresponding blocks of the apparatus 1100 illustrated in FIG. 11. F

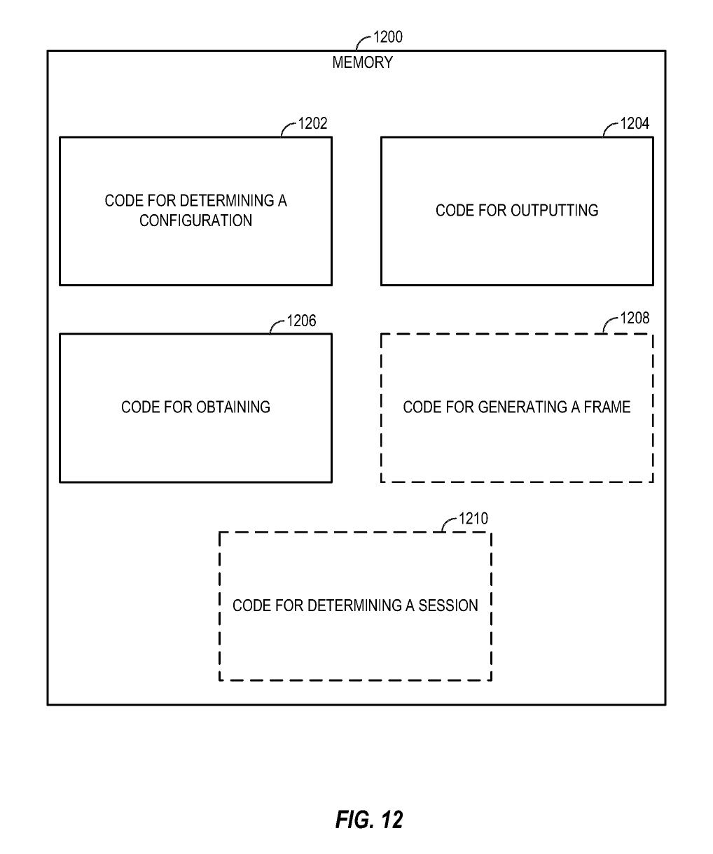

Referring to FIG. 12, programming stored by the memory 1200 (e.g. a storage medium, a memory device, etc.), when executed by a processing system (e.g., the processing system 804 of FIG. 8), causes the processing system to perform one or more of the various functions and/or process operations described herein. For example, the programming, when executed by the processing system 804, may cause the processing system 804 to perform the various functions, steps, and/or processes described herein with respect to FIGS. 1, 2, 3, and 9 in various implementations. As shown in FIG. 12, the memory 1200 may include one or more of code for determining a configuration 1202, code for outputting 1204, code for obtaining 1206, code for generating a frame 1208, and code for determining a session 1210. In some aspects, one of more of the code for determining a configuration 1202, the code for outputting 1204, the code for obtaining 1206, the code for generating a frame 1208, and the code for determining a session 1210 may be executed or otherwise used to provide the functionality described herein for the circuit for determining a configuration 1102, the circuit for outputting 1104, the circuit for obtaining 1106, the circuit for generating a frame 1108, or the circuit for determining a session 1110. In some aspects, the memory 1200 of FIG. 12 may correspond to the memory 806 of FIG. 8.

### Other Aspects

In one aspect, the disclosure provides an apparatus configured for communication that includes a processing system and an interface coupled to the processing system. The interface is configured to obtain information. The processing system is configured to determine a configuration for a report based on the obtained information, wherein the configuration includes a desired frame type for the report. The interface is further configured to output the report for transmission.

Another aspect of the disclosure provides a method for communication including obtaining information; determining a configuration for a report based on the obtained information, wherein the configuration includes a desired frame type for the report; and outputting the report for transmission.

Another aspect of the disclosure provides an apparatus configured for communication. The apparatus includes means for obtaining information; means for determining a configuration for a report based on the obtained information, wherein the configuration includes a desired frame type for the report; and means for outputting the report for transmission.

Another aspect of the disclosure provides a computer-readable medium (e.g., a non-transitory computer-readable medium) storing computer-executable code, including code to obtain information; determine a configuration for a report based on the obtained information, wherein the configuration includes a desired frame type for the report; and output the report for transmission.

Another aspect of the disclosure provides a wireless node that includes a processing system and a transceiver coupled to the processing system. The transceiver is configured to receive information. The processing system is configured to determine a configuration for a report based on the obtained information, wherein the configuration includes a desired frame type for the report. The transceiver is further configured to transmit the report.

### Additional Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As those skilled in the art will readily appreciate, various aspects described throughout this disclosure may be extended to any suitable telecommunication system, network architecture, and communication standard. By way of example, various aspects may be applied to wide area networks, peer-to-peer network, local area network, other suitable systems, or any combination thereof, including those described by yet-to-be defined standards.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example of a storage medium is coupled to the processor such that the processor can read information from, and write information to, the storage medium. In the alternative, the storage medium may be integral to the processor.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner Also, unless stated otherwise a set of elements may comprise one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

1. An apparatus for communication, comprising:
a processing system configured to determine a configuration, wherein the configuration includes a desired frame type for obtaining a report; and
an interface, coupled to the processing system, configured to:
output the configuration for transmission, and
obtain the report according to the configuration after the configuration is output for transmission.

2. The apparatus of claim 1, wherein the report comprises a buffer status report.

3. The apparatus of claim 1, wherein the determination of the configuration comprises selecting the desired frame type based on a type of the report.

4. The apparatus of claim 1, wherein the desired frame type indicates whether the report is to be obtained via a high efficiency (HE) frame or a non-HE frame.

5. The apparatus of claim 1, wherein the desired frame type indicates whether the report is to be obtained via a data frame or a control frame.

6. The apparatus of claim 1, wherein the desired frame type indicates whether the report is to be obtained via a Quality of Service (QoS)-null data frame.

7. The apparatus of claim 1, wherein the desired frame type indicates whether the report is to be obtained via a Quality of Service (QoS) field or a high efficiency (HE) control field in a frame.

8. The apparatus of claim 1, wherein the configuration further includes a desired time for obtaining the report.

9. The apparatus of claim 8, wherein the desired time includes a time within a threshold after the configuration is output for transmission.

10. The apparatus of claim 8, wherein the desired time includes a time during a transmission opportunity (TXOP) initiated by a sender of the report after the configuration is output for transmission.

11. The apparatus of claim 1, wherein the configuration further includes an indication of whether acknowledgement of the configuration is expected.

12. The apparatus of claim 1, wherein the configuration further includes an indication of whether a sender of the report is to wait for an acknowledgement of the report.

13. The apparatus of claim 1, wherein the configuration further includes an indication of a desired content to be included in the report, wherein the desired content includes at least one of:
an indication of whether buffered data exists;
an amount of the buffered data; or
information related to at least one buffered data frame.

14. The apparatus of claim 13, wherein the desired content includes a scaling factor used to express the amount of the buffered data.

15. The apparatus of claim 13, wherein the information related to the at least one buffered data frame includes at least one of:
a number of buffered data frames;
an average number of bytes per buffered data frame; or
a percentage of buffered data frames having a corresponding number of bytes.

16. The apparatus of claim 13, wherein the configuration further includes an indication that the desired content applies to at least one of:
buffered data corresponding to a transmission identifier (TID);
buffered data corresponding to an access category (AC); or
all buffered data.

17. The apparatus of claim 1, wherein:
the processing system is further configured to determine a session for when the configuration is valid; and
the outputting of the configuration comprises outputting the configuration at a beginning of the session.

18. The apparatus of claim 1, wherein the processing system is further configured to:
generate a trigger frame for soliciting the report, the trigger frame comprising a common field that includes the configuration, wherein the outputting of the configuration comprises outputting the trigger frame; or
generate a trigger frame for soliciting the report, the trigger frame comprising a per user field that includes the configuration, wherein the outputting of the configuration comprises outputting the trigger frame; or
generate a trigger frame for soliciting the report, the trigger frame comprising a medium access control (MAC) header with a high efficiency (HE) control field that includes the configuration, wherein the outputting of the configuration comprises outputting the trigger frame.

19. The apparatus of claim 1, wherein the configuration further includes an indication that the configuration applies to at least one of:
an autonomous report; or
a polled report.

20. A wireless node, comprising:
a processing system configured to determine a configuration, wherein the configuration includes a desired frame type for receiving a report; and
a transceiver configured to:
transmit the configuration, and
receive the report according to the configuration after the transmission of the configuration.

21-59. (canceled)
